(19) United States
(12) Patent Application Publication
(10) Pub. No.: US 2008/0234073 A1
(43) Pub. Date: Sep. 25, 2008

(54) Processing Golf Score Data

(76) Inventors: Pal Berg, Mandal (NO); Emir Gorancic, Mandal (NO)

Correspondence Address: CHRISTIAN D. ABEL, ONSAGERS AS, POSTBOKS 6963 ST. OLAVS PLASS, NORWAY, N-0130, NO

(21) Appl. No.: 10/597,412

(22) PCT Filed: Feb. 7, 2005
(86) PCT No.: PCT/NO2005/000045

§ 371 Date: Oct. 18, 2006

(30) Foreign Application Priority Data
Feb. 6, 2004 (NO) 2004 0552

(51) Int. Cl. A63B 57/00; G06K 19/00; G06F 19/00

(52) U.S. Cl. 473/409; 235/487; 700/91

(57) ABSTRACT

The invention relates to a score recording terminal (10) for handling golf score data, and a method for implementing such a terminal. Several score recording terminals are located at certain points on a golf course, and each terminal is adapted to be operated by a golf player by means of a personal smart card (20) during play. The terminal comprises a keypad (12) for the entry of input data from the golf player, a smart card reader (13) for communication with the player's smart card (20), a memory (17) for storage of data (171) and an executable program code (172), and a microprocessor (14). The program code is designed to cause the processor to read score data from the smart card (20), to receive input data from the keypad (12), to calculate new score data on the basis of the received score data and the received input data, and to deliver the new score data back to the smart card (20).

### TECHNICAL FIELD

The invention relates in general to data and communications technical aids for use when playing golf.

More specifically, the invention relates to a score recording terminal for handling golf score data, a method of implementing such a score recording terminal, and a computer program for performing the method.

### BACKGROUND OF THE INVENTION

U.S. Pat. No. 5,949,679 teaches a system for handling golf scores, comprising a central unit and units set out on the golf course. The units set out on the course are used to record strokes/scores, and these units send strokes/scores to the central unit. The central unit processes this data and transmits the players' competition scores to the units on the course. Clearly, in this solution the units on the course are required to communicate directly with the central unit via a communications link.

U.S. Pat. No. 6,246,917 describes an electronic scoring process in which a smart card is used. The document can only be seen to use the smart card as an identifier, and not for storing strokes/scores. For this purpose, however, a separate mobile unit is used.

WO-97/02873 describes a personal, mobile unit that is operated by a golf player during the game. The document also mentions the use of smart cards, but clearly as a transmission unit for player data before and after play. The smart card is also said to be able to contain information about the golf course and identification data for the player. The document cannot be seen to describe a solution which allows the golf player not to have to carry a complex/costly terminal around with him whilst play is in progress.

### SUMMARY OF THE INVENTION

One of the objects of the present invention is to provide a score recording terminal for handling golf score data, a method for implementing such a score recording terminal, and a computer program that performs the method, which do not have the drawbacks of the prior art.

A particular object of the invention is to provide such a score recording terminal, a method and a computer program which permits electronic handling of golf score data, and which does not require the golf player to carry a complex and/or costly terminal or mobile computer around on the golf course during play.

A further object of the invention is to provide such a score recording terminal, a method and a computer program which permits electronic handling of golf score data, and which will function without it being necessary to have a communications link between data collection units set out on the course and a central unit.

In accordance with a first aspect of the present invention, there is provided a score recording terminal as disclosed in independent claim 1 below.

In accordance with a second aspect of the present invention, there is provided a computer-implemented method as disclosed in independent claim 7 below.

In accordance with a third aspect of the present invention, there is provided a computer program as disclosed in independent claim 13 below.

In accordance with a fourth aspect of the present invention, there is provided a computer program as disclosed in independent claim 15 below.

Advantageous embodiments are set forth in the dependent claims.

As a result of the present invention, the score table in question, i.e., score data corresponding to the traditional scorecards is constantly kept up to date in a personal information carrier that is owned by the player. A communications link between the score recording terminals out on the golf course and a central unit is therefore not required, although this may also advantageously be included as an additional, expedient feature of the present invention. The invention therefore permits stand-alone score recording terminals.

### BRIEF DESCRIPTION OF THE DRAWINGS

The attached drawings illustrate an advantageous embodiment of the invention. Together with the description, the drawings serve to explain the principles of the invention.

FIG. 1 is a schematic block diagram illustrating a system which includes score recording terminals in accordance with the invention;

FIG. 2 is a schematic block diagram illustrating a score recording terminal in accordance with the invention;

FIG. 3 is a schematic overview of the score recording terminal seen from above, a cross-sectional view seen from the side, and a view seen from below.

FIG. 4 is a schematic, simplified overview of a golf course illustrating the location of system components.

FIG. 5 is a schematic block diagram illustrating a personal data collection unit in accordance with to the invention;

FIG. 6 is a schematic view illustrating an embodiment of the personal data collection unit in the form of a smart card;

FIG. 7 is a schematic block diagram illustrating a central data collection unit;

FIG. 8 is a schematic block diagram illustrating a communication unit for use with the central data collection unit;

FIG. 9 is a schematic flow diagram illustrating a method in accordance with the invention;

FIG. 10 is a schematic flow diagram indicating two initialisation processes;

FIG. 11 is a schematic flow diagram indicating two final scoring processes; and

FIG. 12 shows a score table which schematically illustrates score data stored in the information carrier.

FIG. 13 is a schematic block diagram illustrating the functional relation between different system components for different scenarios.

### DETAILED DESCRIPTION OF A PREFERRED EMBODIMENT

In what follows the invention will be described in more detail as an example with reference to the drawings. Where possible, the same reference numerals are used for the identical elements in the different drawings.

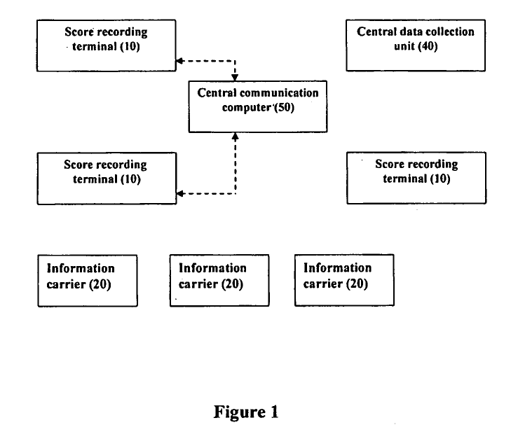

FIG. 1 is a schematic block diagram illustrating a simplified example of a system which includes score recording terminals in accordance with the invention.

The system shown in FIG. 1 is intended to be used on a golf course. The system comprises three score recording terminals 10, which in practice are located at different points on the golf course. The system further comprises a central communication computer 50, typically a computer provided with big screen for the display of player results in a clubhouse. The system also comprises a plurality (shown: three) of personal information carriers 20 in the form of smart cards, and a central data collection unit 40 for opening/initiation of the personal information carriers 20 before play, and final scoring based on the information in the carriers after play.

Each score recording terminal 10 is designed to communicate with users, more particularly golf players, in connection with the recording of data associated with a round of golf during the course of play. Communication between each score recording terminal 10 and a user takes place by means of a personal information carrier 20, preferably in the form of a smart card.

A score recording terminal 10 is located in connection with a hole or at a tee on the golf course, so that the player can, in an expedient manner, record data associated with the round, in particular the number of stokes for the previous hole.

Thus, in practice, the system will comprise a greater number of score recording terminals 10 than the three which for the sake of simplicity are shown in FIG. 1. The system will in practice also comprise a greater number of information carriers 20 than the three which for the sake of simplicity are shown in FIG. 1.

The score recording terminal 10 shown at the bottom to the right in FIG. 1 is a stand-alone unit, and thus operates independently, without any direct communication with the central computer 50. This is made possible as the necessary, basic handling of the score data is carried out on transmission between the score recording terminal and the golf player's information carrier 20. A communications link between the score recording terminal and the central computer 50 is therefore not required for this basic embodiment of the invention. Nevertheless, such communication may be advantageous, particularly with a view to keeping the central computer 50 constantly up to date with current data associated with play on the course, e.g., in connection with tournaments.

The two score recording terminals 10 shown to the left in FIG. 1 are, in accordance with an advantageous embodiment of this kind, each designed to provide data communication (shown in a broken line) between the score recording terminal 10 and the central computer 50. The communication is preferably wireless, carried out using a standard form of wireless data communication for distances of up to 1000 metres out of doors. A suitable communications form is known as wireless LAN. If necessary, suitable repeaters are located on the golf course area so as to obtain the necessary range.

The central communication device 50 is similarly designed for the same type of data communication with a plurality of score recording terminals 10.

Of course, it will be understood that the data communication between the score input devices 10 and the central computer 50 may alternatively be realised using cable, e.g., fibre-optic cable laid in the ground.

The central data collection unit 40 is located centrally on the golf course area, preferably in connection with a clubhouse. The central data collection unit 40 is designed to communicate with a user's personal information carrier 20, in particular in connection with the initiation of the information carrier 20 before play, and for retrieving data from the information carrier 20 after play.

The central data collection unit 40 may in the simplest case be a stand-alone unit, as illustrated in FIG. 1. Alternatively, it may be operatively connected to the central communication device 50, for example by a hardwired or wireless data communications link.

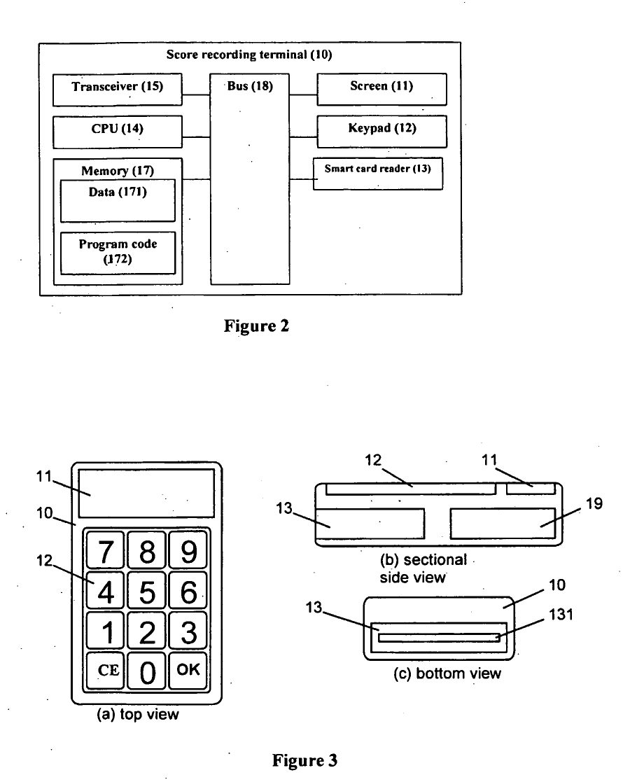

FIG. 2 is a schematic block diagram illustrating a score recording terminal 10 in accordance with the invention.

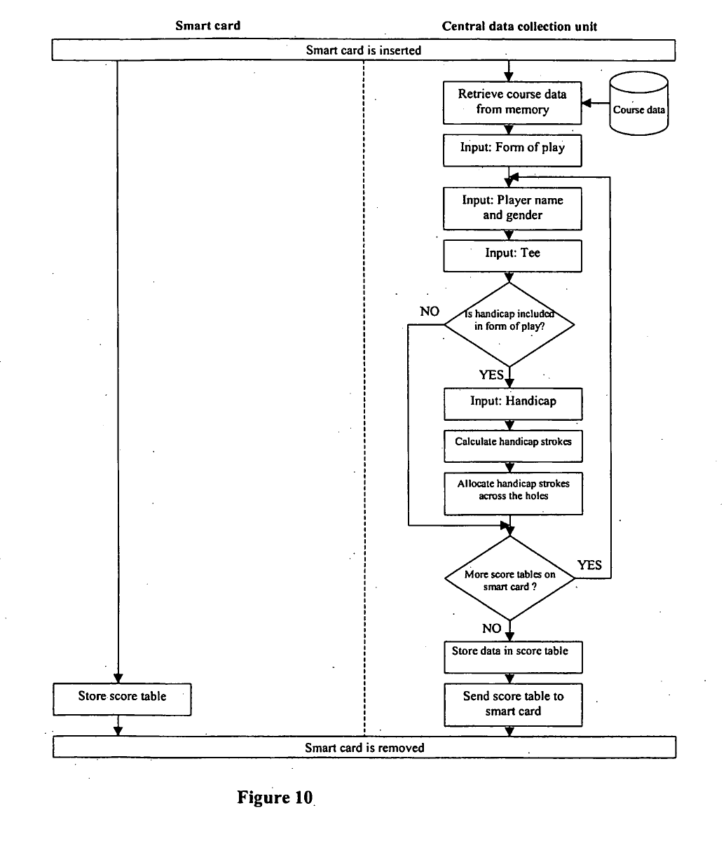

The score recording terminal 10 is constructed in the form of a digital, processor-based unit. It comprises an input device 12 for the entry of input data from a user, more particularly a keypad. The score recording terminal further comprises a first communication device 13, preferably a smart card reader, for communication with a personal information carrier 20 (not shown in FIG. 2), which is preferably a smart card. The score recording terminal 10 further comprises a memory 17 for storage of data 171 and an executable program code 172. The aforementioned components 12, 13, 17 are connected by means of a bus 18 to a processing unit 14 in the form of a microprocessor. When the program code 172 contained in the memory 17 is executed by the microprocessor 14, the score recording terminal 10 is caused to perform a method in accordance with the invention in order to handle score data, and which is explained in more detail below with reference to FIG. 10.

The score recording terminal 10 is also advantageously provided with a transceiver 15 for providing data communication between the score recording terminal and the central computer 50.

The transceiver 15 may, for example, be realised as a communication module for wireless LAN, such as a wireless access point module for 2.4 GHz radio communication in accordance with the standard IEEE 801.11b. A module of this kind is known in the market under the name D-Link DWL-900AP+. However, other suitable transceivers 15 may be chosen freely by those skilled in the art.

FIG. 3 is a schematic overview of a score recording terminal 10 of the simplest type, i.e., without a transceiver 15 for data communication with the central computer 50. The figure shows (a) a top view of the terminal, (b) a cross-sectional side view of the terminal, and (c) a bottom view of the terminal. FIGS. 3(a)-(c) show a possible location of the display 11, the keypad 12, the smart card reader 13, and the slot for 131 for receiving a smart card 20. FIG. 3(b) also indicates schematically the position of other electronic components 19, including the microprocessor 14, the memory 17 and the bus 18.

It will be understood that a transceiver 15, such as a wireless LAN module as mentioned above, may be contained in the electronic components 19 of the score recording terminal 10, or that the score recording terminal 10 may be connected to an external transceiver 15. Alternatively, the score recording terminal 10 may comprise a wired connection to the central computer 50.

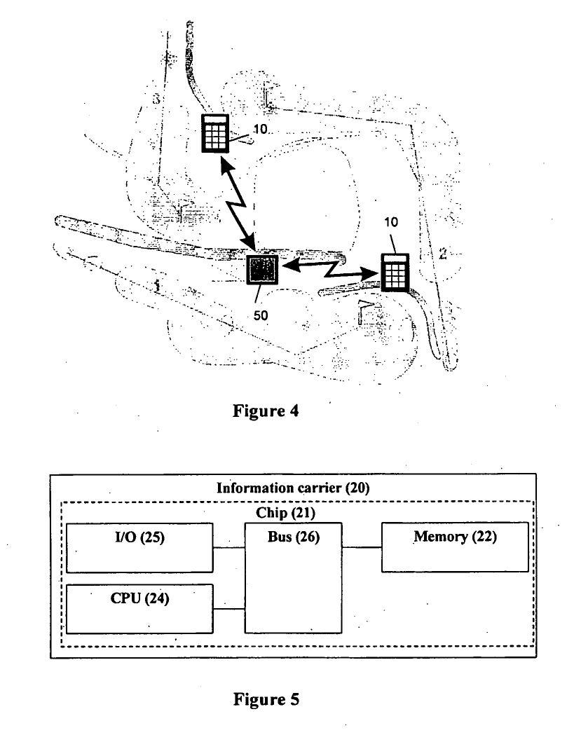

FIG. 4 is a schematic, simplified overview of a golf course, which illustrates the location of some of the system components shown in FIG. 1.

In FIG. 4 two score recording terminals 10 are set out in connection with a tee, or more particularly at an area between a hole and the next tee in the game. FIG. 4 also shows that the two score recording terminals are wirelessly connected for communication with the central computer 50.

In addition (not shown) a random number of stand-alone score recording terminals 10 without connection to the central computer 50 may be positioned on the golf course.

FIG. 5 is a schematic block diagram illustrating a personal information carrier in the form of a smart card.

The smart card 20 comprises, in the usual way, an electronic chip 21, containing a bus-based microprocessor architecture including a bus 26, a microprocessor 24, I/O-circuits 25 and a memory 22. The I/O-circuits comprise contact means for providing communication between the smart card 20 and a smart card reader.

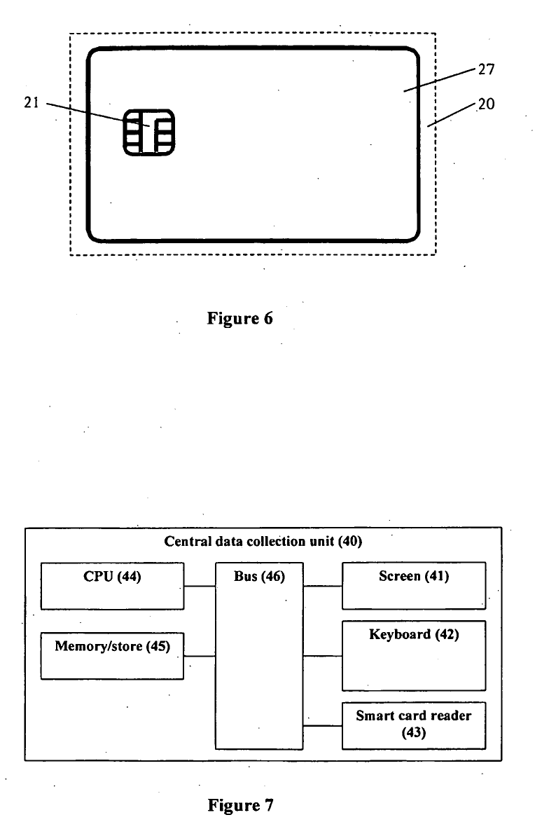

FIG. 6 is a schematic view illustrating the outer appearance of the personal information carrier in the form of a smart card 20. As shown, the smart card 20 comprises, in the usual way, an electronic chip 21 as stated in the reference to FIG. 5, and an encapsulation 27 in the form of a plastic card.

FIG. 7 is a schematic block diagram illustrating a central data collection unit.

The central data collection unit 40 is realised in the form of a computer with standard, bus-based microprocessor architecture, comprising a bus 46, connected to a microprocessor 44, a memory and mass store 45, a display device in the form of a screen 41, input devices for operation by a user, more particularly a keyboard 42, and a smart card reader 43. The memory contains data and an executable program code, which upon execution by the microprocessor 44 enables the central data collection unit to communicate with a user by means of the screen 41, the keypad 42 and the smart card reader 43. In particular, the program code contains instructions for initiating the smart card 20 before play, and for carrying out a final scoring procedure on the basis of data read out from the smart card 20 after play.

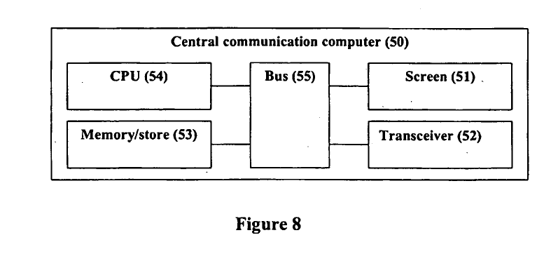

FIG. 8 is a schematic block diagram illustrating a central communication computer.

The central communication unit 50 is realised as a computer having standard, bus-based microprocessor architecture, comprising a bus 55, connected to a microprocessor 54, memory circuits and mass store 53, a display device in the form of a screen 51, and a communication component for wireless data communication, in the form of a transceiver 52.

The transceiver 52 will be of the same type as the transceiver 15 mentioned above with reference to FIG. 2, or at least of a type that is designed to communicate with a plurality of score input devices 10 of the type that is provided with data communication devices.

In the alternative case that one or more score recording terminals 10 are designed to communicate with the central computer 50 by a wired connection, such as a fibre-optic cable in the ground, the central computer is provided with corresponding communication interfaces to support such a connection.

Typically, the central computer will be provided with a big screen 51, for display of play-related information for members of the public in, e.g., the golf course clubhouse. The computer will thus be operated by a computer program which handles input data from the connected data collection units, and which displays information derived, inter alia, from this data on the screen 51.

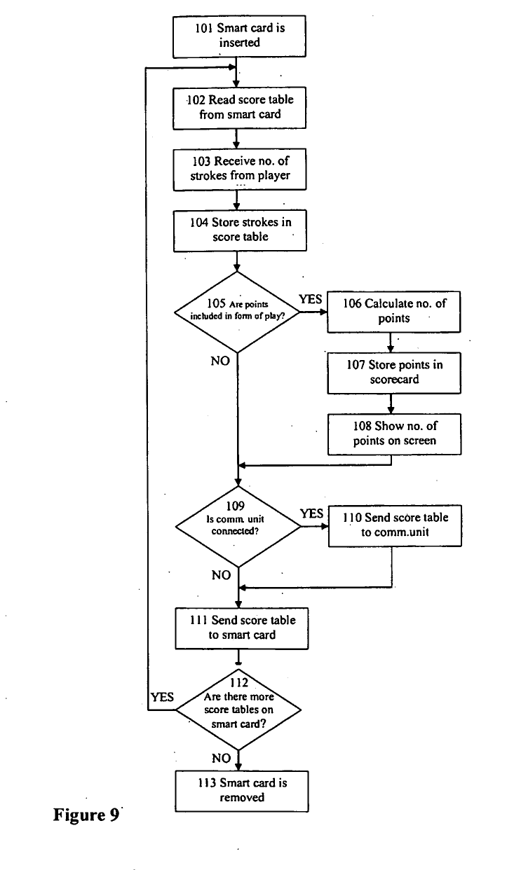

FIG. 9 is a schematic flow diagram which illustrates a computer-implemented method for handling golf score data, in accordance with the invention.

The method is performed by the score recording terminal 10.

The method is performed in response to the execution of the program code 172 contained in the memory 17 of the score recording terminal by the microprocessor 14.

Initially, the user's personal information carrier 20, more specifically the smart card 20, is inserted 101 into the smart card reader 13 in the score recording terminal 10. There is thus, for the further steps of the method, a communications link between the score recording terminal 10 and the smart card 20.

A reading step 102 is then carried out, in which score data from the smart card 20 is input and included in data 171 contained in the memory 17 of the score recording terminal 10.

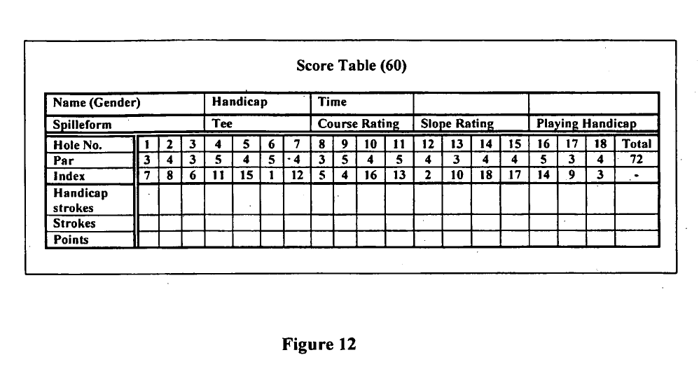

The score data will more specifically be understood as a score table. An example of a score table is illustrated in more detail below with reference to FIG. 12.

Next, a receiving step 103 is carried out, in which input data is received from the user via the keypad or a similar input device 11. This input data comprises at least the number of strokes the user has used in connection with recent play on the golf course, more particularly the number of strokes for the previous hole.

Then a calculation and storage step 104 is carried out, in which new score data is calculated on the basis of the input score data and the received input data, and is stored in the score data, i.e., the score table, contained in the memory 17.

Advantageously, the first decision step 105 is then carried out, in which on the basis of the form of play data received from the smart card 20 it is decided whether points are included in the form of play. If this it not the case, the process continues to the second decision step 109. If this is the case, a point calculation step 106 is carried out, the calculated points are stored 107 in the score data contained in the memory 17, and the calculated points are shown 108 on the screen 11.

As a result, the new, calculated score data will also comprise a point score, in the case where the form of play data indicates that points should be included in the form of play.

Advantageously, the second decision step 109 is then carried out, in which it is decided whether the score recording terminal 10 is operatively and communicatively connected to the central communication computer 50, in other words whether a transceiver 15 is present and operative in the score recording terminal 10. If this is not the case, the process continues to the transmission step 111. If, however, there is such an operative connection, the sending step 110 is first carried out, in which the new score data is sent to the transceiver 15 for relaying to the central computer 50, whereupon the process continues to the transmission step 111.

In the updating step 111 the new score data, more specifically the updated score table, is transmitted to the personal smart card 20 via the smart card reader 13.

FIG. 10 is a schematic flow diagram indicating two initialisation processes.

The initialisation processes are carried out in parallel and by interaction between the smart card 20 and the central data collection device 40.

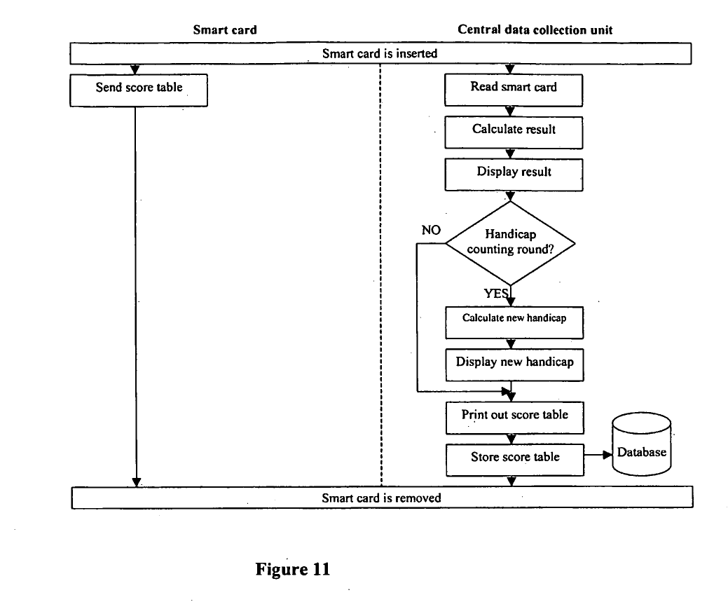

The first initialisation process, illustrated on the left in FIG. 11, is performed by the processor 24 in the smart card 20, controlled by a program code contained in an area of the memory 36 in the smart card 20. This process consists, in the simplest, illustrated case, of an initial score table being received from the central data collection unit 40, and being stored on the smart card 20.

It will be understood that the processing possibilities of the smart card open the way for further possibilities, e.g., including encryption and certificate functions.

The second initialisation process, illustrated to the right in FIG. 11, is performed by the processor 44 in the central data collection unit 40, controlled by a program code contained in a memory area comprised of memory/store 45.

Course data, including slope, course rating, par and index for the course holes, is retrieved from memory/store 45. Data associated with desired form of play, identification data (name, gender) for the player, and an identification of the tee, is input from the keyboard 42, operated by the player. If handicap is included in the desired form of play, handicap is also entered, and handicap strokes are calculated and allocated across the holes. The process is repeated as shown in FIG. 10 if there are several score tables on the smart card. Lastly, the generated score table is stored in memory/store 45, whereupon it is ultimately transmitted to the smart card 20 and stored there.

FIG. 11 is a schematic flow diagram showing two final scoring processes.

The final scoring processes are carried out in parallel and by interaction between the smart card 20 and the central data collection device 40.

The first final scoring process, illustrated on the left in FIG. 11, is performed by the processor 24 in the smart card 20, controlled by a program code contained in an area of the memory 36 in the smart card 20. This process consists in the simplest, illustrated case of the score table being output from the memory in the smart card and transmitted to the central data collection unit 40.

It will be understood that the processing possibilities of the smart card open the way for further possibilities, e.g., including encryption and certificate functions.

The second final recording process, illustrated on the right in FIG. 11, is performed by the processor 44 in the central data collection unit 40, controlled by a program code contained in a memory area comprised of memory/store 45.

First, a score table is input from the smart card 20. A result of the round of golf played is calculated on the basis of the entered score table, and is displayed on the screen 41. It is decided whether the round played counts for handicap, and if it does, a new handicap is calculated and displayed. Provided that a printer is also operatively connected to the central data collection unit 40, the score table is subsequently printed out by this printer. The score table is also stored in the memory/store 45 of the central data collection device 40.

FIG. 12 illustrates score data stored in the information carrier, in the form of a score table.

FIG. 12 shows an illustrative example of a score table 60, comprising a data structure illustrated with eight lines and a varying number of columns for the different lines.

Data that is specific to the golf player is given in the top line, i.e., the fields Name (gender), Handicap, Time.

Data that is specific to the golf course is given in the fields Course Rating and Slope Rating in the second line down, and in the fourth and fifth lines down, where values for Par and Index are entered for each of the 18 holes of the course. A separate field indicates total par for the 18 holes.

Data that is specific to the actual round being played is given in the fields Form of Play, Tee and Playing Handicap in the second line down, and in the sixth, seventh and eighth line down, where there is a space for filling in values for respectively Handicap Strokes, Strokes and Points for each of the 18 holes. Separate fields indicate the total number of Strokes and the total number of Points.

Playing handicap and handicap strokes will be calculated from the round data before play on the basis of the player's and the course's data, cf. formula [1]:

Playing handicap=player's handicap×slope rating/113+course rating−course par. [1]

Strokes and points will be entered and calculated, cf. formula [2] during the round:

Number of points=hole par−net strokes+2 [2]

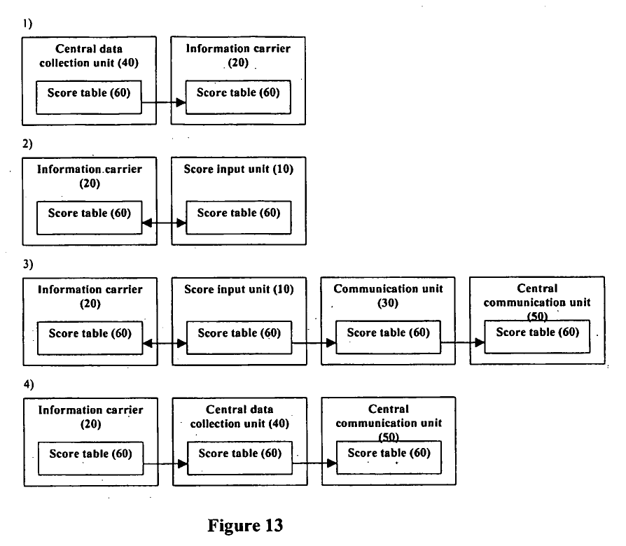

It will be understood that FIG. 13 is given for illustrative purposes, and that a suitable data structure can easily be realised for storage in the smart card 20, and in the memory/store of the various terminals/units in which the table is to be found. The values given in the score table shown in FIG. 13 are of course only used as an example.

FIG. 13 illustrates the functional relation between different system components for different scenarios.

The score table 60 contained within the smart card 20 holds information about the game and is the only information exchanged between the components.

Scenario 1) illustrates that the score table 60 is downloaded from the central data collection unit 40 to the smart card 20. This happens before play.

Scenario 2) illustrates a simple scoring process that is carried out during the game. The score table 60 is sent from the smart card 20 to the score recording terminal 10, where the player enters stroke data associated with the hole that has just been played during the round. This stroke data is then stored in the score table 60, which is transmitted back to the smart card 20.

Scenario 3) is an extension of scenario 2), where the score table 60 in addition is transmitted via the wireless communications link to the central communication computer 50.

Scenario 4) outlines the final scoring process, where the final updated score table 60 is transmitted to the data collection unit 40. It may also be expedient that the score table 60 is also transmitted from the data collection unit 40 to the central communication unit 50 for display on the screen 51, e.g., during tournaments.

A computer program, including an executable program code, which performs the method in accordance with the invention when the computer program is executed by a processing device in a score recording terminal or other suitably equipped computer, may easily be implemented by those skilled in the art on the basis of the detailed description given above, in particular with reference to FIG. 9 and the associated description. Such a computer program may, in concrete terms, be realised in the form of a program code contained in a memory, either isolated or included in the memory 17 of the score recording terminal 10. Alternatively, the program code may be on a magnetic, optical or semi-conductor based storage medium, or the program code may be carried by a propagated signal, for example on transmission between computers linked together in a network.

In one particular embodiment, the program code which performs the method may be realised in the form of a script which is stored in the personal information carrier, and which is input in the score recording terminal when the information carrier is inserted into the terminal. In this case, the score recording terminal will be equipped with a script interpretation program as for instance JavaScript, which interprets the script code that is contained in the information carrier, and which also translates the script code into executable program instructions that are carried out by the processing device contained within the terminal.

Many modifications and adaptations of the present invention will naturally be apparent to the skilled person, either upon interpreting the present description of the invention or on putting the invention into practice.

The above detailed description is presented specifically with a view to illustrating and describing an advantageous embodiment of the invention. However, the description in no way limits the invention to the specific embodiment that is described in detail.

For example, the information carrier 20 is specifically disclosed as a smart card. This is particularly expedient for certain embodiments of the invention, e.g., with a view to encryption and certificate functions, which will require processor power in the information carrier 20. The basic features of the invention may, however, be obtained just as readily by using a passive information carrier such as a magnetic medium, e.g., a magnetic strip card or a memory chip.

Furthermore, it will be understood that the processes for initialisation and final scoring could also be carried out in any computer equipped with a suitable smart card reader. For example, one embodiment of the score input unit 10 may also comprise program modules which allow the execution of these processes, so that initialisation and final scoring can be performed by a score recording terminal 10.

Further modifications and variations will be obvious to the skilled person in the light of the above description. The scope of the invention is apparent from the patent claims below and their equivalents.

1. A score recording terminal (10) for handling golf score data, comprising
an input device (12) for entry of input data from a user;
a first communication device (13) for communication with a personal information carrier (20);
a memory ( 17) for storage of data (171) and an executable program code (172); and
a processing device (14), wherein the processing device (14) is arranged
to receive score data from the personal information carrier (20);
to receive input data from the input device (12);
to calculate new source data on the basis of the received score data and the received input data; and
to deliver the new score data to the personal information carrier (20).

2. A terminal in accordance with claim 1, wherein the processing device is further adapted
to receive form of play data which indicates current form of play from the personal information carrier (20),
wherein said step of calculating new score data includes calculating a score on the basis of the received input data and said form of play data.

3. A terminal in accordance with one of claims 1-2, further comprising a second communication device (15) for communication with a central computer (50), wherein the processing device (14) is further adapted
to deliver the new score data to the central computer (50) via the second communication device (15).

4. A terminal in accordance with one of claims 1-3, further comprising a display device (11), and
wherein the processing device (14) is further adapted to display output data domprising said source data on the display device (11).

5. A terminal in accordance with one of claims 1-4, wherein
the input device (12) comprises a keypad;
the first communication device (13) comprises a smart card reader;
the personal information carrier (20) comprises a smart card;
the processing device (14) comprises a microprocessor;
the display unit (11) comprises a screen; and
wherein said steps performed by the proocessing device (14) are performed in thar the processing device (14) executes said executable code (19) contained in said memory (17).

6. A terminal in accordance with claims 1-4, wherein
the input device (12) comprises a keypad;
the first communication device (13) comprises a smart card reader;
the personal information arrier (20) comprises a smart card;
the processing device (14) comprises a microprocessor, adapted, with the aid of a script interpretation program, to interpret a script;
the display unit (11) comprises a screen; and wherein said steps carried out by the processing device (14) are carried out in that the processing device (14) interprets a script with a code that has been input from said personal information carrier (20).

7. A computer-implemented method for handling golf score data, for execution by a score recording terminal (10), wherein the score recording terminal (10) is adapted to communicate with a personal information carrier (20), and wherein the method comprises the following steps:
receiving score data from the personal information carrier (20);
receiving input data from a user via an input device (11);
calculating new score data on the basis of the recieved score data and the received input data; and
sending the new score data to the personal information carrier (20).

8. A method in accordance with claim 7, further comprising the step of
receiving form of play data which indicates current form of play from the personal information carrier (20), and
wherein said step of calculating new score data comprises calculating a point score on the basis of the received input data and said form of play data.

9. A method in accordance with one of claims 7-8, further comprising the step of
delivering the new score data to the central computer (50) via a second communication device (15).

10. A method in accordance with one of claims 7-9, further comprising the step of
displaying output data comprising said score data on a display device (11).

11. A method in accordance with one of claims 7-10, wherein
the input device (12) comprises a keypad;
the first communication device (13) comprises a smart card reader;
the personal information carrier (20) comprises a smart card;
the processing device (14) comprises a microprocessor;
the display unit (11) comprises a screen, and
wherein the steps of the method are carried out by the processing device (14) in that the processing device (14) executes said executable code (19) contained in said memory (17).

12. A method in accordance with one of claims 7-10, wherein
the input device (12) comprises a keypad;
the communication device (13) comprises a smart card reader;
the persoanl information carrier (20) comprises a smart card;
the processing device (14) comprises a microprocessor, adapted, with the aid of a script interpretation program, to interpret a script;
the display unit (11) comprises a screen, and
wherein the steps of the method are carried out by the processing device (14) in that the processing device (14) interprets a script with a code that has been input from said personal information carrier (20).

13. A computer program for handling golf score data, for execution by a score recording terminal (10) including a processing device (14), comprising instructions which on execution by the processing device (14) cause the score recording terminal (10) to perform a method in accordance with one of claims 7-11.

14. A computer program in accordance with claim 13, i the form of a program code contained in a memory, on a storage medium or carried by a propagated signal.

15. A computer program for handling golf score data, for interpretation and execution by a score recording terminal (10) which comprises a processing device (14) with a script interpretation program, wherein the program comprises a script code which on interpretation by script interpreting program and further execution by the processing device (14) causes the score recording terminal (10) to perform a method in accordance with one of claims 7-12.

16. A computer program in accordance with claim 15, in the form of a script code contained in said personal information carrier.
